(19) United States
(12) Patent Application Publication
(10) Pub. No.: US 2018/0290414 A1
(43) Pub. Date: Oct. 11, 2018

(54) PRESS SYSTEM AND CONTROL METHOD FOR PRESS SYSTEM

(71) Applicant: KOMATSU INDUSTRIES CORPORATION, Kanazawa-shi, Ishikawa (JP)

(72) Inventor: Takahiko KUROKAWA, Nonoichi-shi, Ishikawa (JP)

(73) Assignee: KOMATSU INDUSTRIES CORPORATION, Kanazawa-shi, Ishikawa (JP)

(21) Appl. No.: 15/557,853

(22) PCT Filed: Mar. 9, 2016
(86) PCT No.: PCT/JP2016/057305

§ 371 Date: Sep. 13, 2017

(30) Foreign Application Priority Data
Apr. 30, 2015 (JP) 2015-093052

(51) Int. Cl. B30B 15/00

(52) U.S. Cl. CPC B30B 15/0094

(57) ABSTRACT

A press system includes: a measurement unit configured to measure a press load applied for pressing a workpiece; a calculation unit configured to calculate a workload based on the press load measured by the measurement unit; a determination unit configured to make a determination about whether the workload calculated by the calculation unit exceeds an allowable value; and a notification unit configured to provide notification of an abnormality based on a result of the determination by the determination unit. Accordingly, in response to pressing with an overload higher than an allowable value, notification of an abnormality can be provided.

### TECHNICAL FIELD

The present invention relates to press systems, and particularly to press systems for pressing a workpiece.

### BACKGROUND ART

Recently, there have been demands for enhancement of the accuracy of pressed products (higher accuracy of shape and dimension) as well as for increase of the pressing speed for enhancement of the productivity.

Usually, when a process such as deep drawing or forming for example that takes a certain long time is performed with a press machine, a method is commonly executed that presses a workpiece by continuously applying a load of a predetermined value or more to the workpiece from the start to the end of the pressurization. The load applied at this time may be at least larger than a minimum load required for forming a workpiece. When a pressing process is performed, a slide is controlled so that a load of a predetermined value or more is applied continuously.

When a process that requires a large load for forming is performed on a workpiece with a high load (high workload), the press machine may make an emergency stop due to an overload abnormality.

Specifically, in an electric servo press in which an electric servo motor is used, excessively large load current may cause the electric servo motor to generate heat, resulting in a temperature increase. Then, for the sake of thermal load protection against the temperature increase of the electric servo motor, load current/time characteristics appropriate for temperature characteristics of the electric servo motor are defined, and a protective function for preventing an overload of the electric servo motor is provided.

For example, Japanese Patent Laying-Open No. 2004-174558 (Patent Document 1) discloses a method for determining an allowable motor limit by calculating the workload of the motor of the electric servo press based on the value of electric current and the output time.

### CITATION LIST

### Patent Document

PTD 1: Japanese Patent Laying-Open No. 2004-174558

### SUMMARY OF INVENTION

### Technical Problem

For each press machine, an allowable workload as a value of a design specification is defined. In most cases, however, an operator continues production without being able to know the workload during the production.

Accordingly, an electric servo press for example may suddenly make an emergency stop due to an overload of a servo amplifier. Recovery takes a long time, leading to a problem of a considerable decrease of the productivity.

In a flywheel press machine, when high-load press working is continued, an energy accumulated in a flywheel is excessively consumed. As a result, decrease of the rotational speed of the flywheel occurs to cause a sudden emergency stop of the press machine. Then, the process is suspended, leading to a problem of a decrease of the productivity.

The present invention has been made to solve the above-described problems, and an object of the invention is to provide a press system and a control method for the press system that enable notification of an abnormality to be provided upon occurrence of overload press working.

### Solution to Problem

A press system according to an aspect includes: a detection unit configured to detect a press load applied for pressing a workpiece; a calculation unit configured to calculate a workload based on the press load detected by the detection unit; a determination unit configured to make a determination about whether the workload calculated by the calculation unit exceeds an allowable value; and a notification unit configured to provide notification of an abnormality based on a result of the determination by the determination unit.

According to the present invention, the calculation unit calculates a workload based on the press load detected by the detection unit, the determination unit makes a determination about whether the workload calculated by the calculation unit is higher than an allowable value, and the notification unit provides notification of an abnormality based on a result of the determination by the determination unit. Accordingly, in response to pressing with an overload higher than an allowable value, notification of an abnormality can be provided.

Preferably, the calculation unit is configured to calculate an integral value of a product of a slide stroke and the press load measured by the measurement unit. With this calculation, the workload of pressing can be calculated with the simple method.

Preferably, the notification unit is configured to output abnormality information to a display. The abnormality information can be output to the display to visually notify an operator of the abnormality.

Preferably, the press system further includes an adjustment unit configured to adjust pressing of the workpiece based on a result of the determination by the determination unit. The adjustment unit can adjust pressing of a workpiece to prevent interruption of work for pressing.

A control method for a press system according to an aspect includes: detecting a press load applied for pressing a workpiece; calculating a workload based on the detected press load; making a determination about whether the calculated workload exceeds an allowable value; and providing notification of an abnormality based on a result of the determination.

According to the present invention, the workload is calculated based on the detected press load, a determination is made about whether the calculated workload is higher than an allowable value, and notification of an abnormality is provided based on a result of the determination. Accordingly, in response to pressing with an overload higher than an allowable value, notification of an abnormality can be provided.

### Advantageous Effects of Invention

A press system and a control method for the press system of the present invention enable notification of an abnormality to be provided in response to overload pressing.

### BRIEF DESCRIPTION OF DRAWINGS

FIG. 1 is a diagram illustrating an external configuration of a press machine 1 according to one embodiment of the present invention.

FIG. 2 is a diagram illustrating a configuration of main parts of press machine 1 according to one embodiment of the present invention.

FIG. 3 is a block diagram showing a functional configuration of a controller 40 according to the present embodiment.

FIG. 4 is a diagram illustrating a load waveform of a press load according to the present embodiment.

FIG. 5 is a diagram illustrating a method for determining an overload abnormality of press machine 1 according to the present embodiment.

FIG. 6 is another diagram illustrating a method for determining an overload abnormality of press machine 1 according to the present embodiment.

FIG. 7 is a flow diagram illustrating a process for determining an overload abnormality by controller 40 of press machine 1 according to the present embodiment.

FIG. 8 is a side cross-sectional view showing main parts of a servo press 1#.

FIG. 9 is a plan view with a partial cross section showing other main parts of servo press 1#.

FIG. 10 is a diagram illustrating a method for determining an overload abnormality of another press machine according to the present embodiment.

### DESCRIPTION OF EMBODIMENTS

Embodiments will be described in detail with reference to the drawings. In the drawings, the same or corresponding parts are denoted by the same reference characters, and a description thereof will not be repeated.

<Overall Configuration>

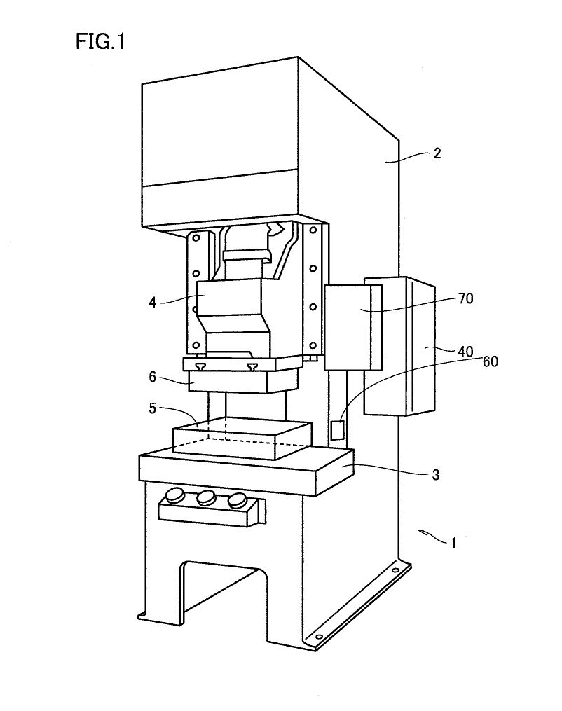

FIG. 1 is a diagram illustrating an external configuration of a press machine 1 according to one embodiment of the present invention.

Referring to FIG. 1, press machine 1 includes a body frame 2 having a horizontal U shape as seen in side view, a bolster 3 disposed on a lower section of body frame 2, a slide 4 supported on an upper section of body frame 2 so that the slide is movable up and down, a control panel 70, a controller 40, and a load sensor 60.

On the top surface of bolster 3, a lower mold 5 is mounted. On the lower surface of slide 4, an upper mold 6 is mounted to face lower mold 5.

On slide 4, load sensor 60 configured to output a value of a load applied for pressing is mounted.

On a lateral side of body frame 2, controller 40 configured to control press machine 1 is disposed. On a front side of body frame 2, control panel 70 is disposed for operating press machine 1.

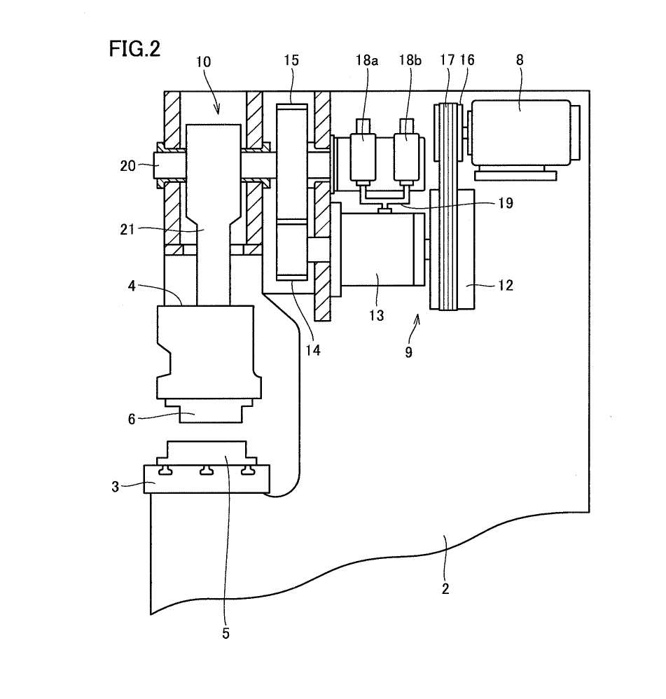

FIG. 2 is a diagram illustrating a configuration of main parts of press machine 1 according to one embodiment of the present invention.

Referring to FIG. 2, in the upper section of body frame 2, an electric motor 8, a power transmission mechanism 9, and a transformation mechanism 10 configured to transform rotations of electric motor 8 into up-and-down motion of slide 4 are provided.

Power transmission mechanism 9 includes a flywheel 12, a clutch brake device 13, a first gear 14, and a second gear 15.

Flywheel 12 is connected through a V belt 17 to a pulley 16 fixed to an output shaft of electric motor 8. Clutch brake device 13 is connected to flywheel 12. In the vicinity of clutch brake device 13, two air solenoid valves 18a, 18b are provided. To these solenoid valves 18a, 18b, air is fed from an air tank (not shown), and air is further fed from these solenoid valves 18a, 18b to clutch brake device 13 through an air pipe 19. Accordingly, clutch brake device 13 can transmit (clutch on) rotation of flywheel 12 to first gear 14 or interrupt (clutch off) rotation of flywheel 12. Clutch brake device 13 can also apply the brake (brake on) to or release the brake (brake off) from rotation of first gear 14. First gear 14 is attached to a clutch side of clutch brake device 13 and second gear 15 meshes with first gear 14.

Transformation mechanism 10 includes a crankshaft 20 provided coaxially with second gear 15, and a connecting rod 21 having an upper end rotatably attached to an eccentric portion of crankshaft 20. To a lower end of connecting rod 21, slide 4 is rotatably attached.

Press machine 1 further includes components such as clutch brake control pneumatic circuit and a press angle detector (not shown). The clutch brake control pneumatic circuit is connected to two air solenoid valves 18a, 18b for controlling application and release of the clutch brake.

The press angle detector is configured to detect a rotational angular position of crankshaft 20. The press angle detector can be used to detect the position and the direction of movement of slide 4.

<Configuration of Controller of Press Machine 1>

Next, controller 40 of press machine 1 will be described.

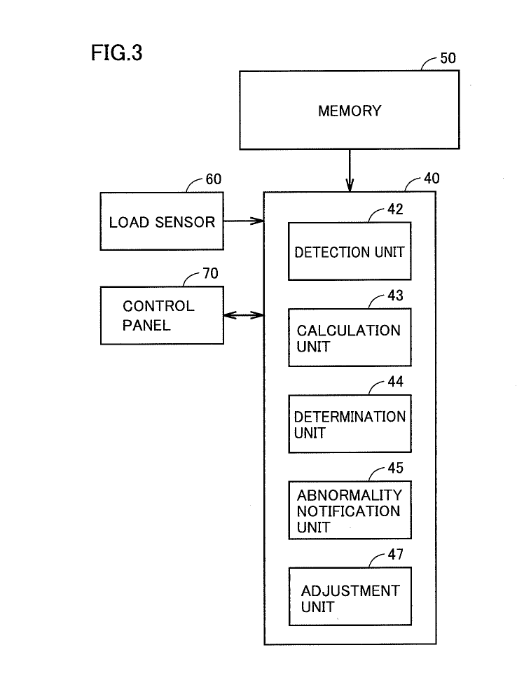

FIG. 3 is a block diagram showing a functional configuration of controller 40 according to the present embodiment.

Referring to FIG. 3, controller 40 according to the present embodiment controls the whole of press machine 1. While illustration of details in the drawing and description thereof of controller 40 are not given herein, controller 40 is configured to include a CPU, a high-speed arithmetic operation processor or the like as a main device, and configured to also include a computer device performing an arithmetic/logical operation on input data in accordance with a predetermined procedure, and an input/output interface for input/output of command current.

Controller 40 according to the present embodiment includes a detection unit 42, a calculation unit 43, a determination unit 44, an abnormality notification unit 45, and an adjustment unit 47.

Controller 40 is connected to a memory 50 configured as an appropriate storage medium such as ROM or RAM. In memory 50, a program(s) for controller 40 to implement various functions is(are) stored. Memory 50 is also used as a work area for execution of various arithmetic operations. Memory 50 may be provided in either the outside or the inside of controller 40.

Controller 40 is connected to control panel 70 as well as load sensor 60.

Controller 40 can determine the state of the press load of slide 4 by means of load sensor 60. Strain gauge, pressure oil sensor, or the like may be used as the load sensor. The load sensor can be disposed at a proper position appropriately by those skilled in the art.

Detection unit 42 receives input of data on a measurement taken by load sensor 60 to detect a press load applied for press working. Detection unit 42 may also receive and detect an externally given instruction to execute a predetermined process. For example, detection unit 42 may receive an instruction to stop press activation to cause press working to stop.

Calculation unit 43 calculates a workload of press working based on the press load detected by load sensor 60 as will be described later herein.

Determination unit 44 determines whether press working is overload press working or not. Specifically, determination unit 44 determines whether the workload of press working calculated by calculation unit 43 falls within a range of an allowable workload.

Abnormality notification unit 45 makes notification of an abnormality based on the result of the determination by determination unit 44. Specifically, based on the result of the determination by determination unit 44, abnormality notification unit 45 instructs control panel 70 to output information indicating that the press working is overload press working. Following the instruction, control panel 70 outputs the information to the display. Alternatively, control panel 70 may be configured to output an alarm. When press machine 1 is connected to an external device through a network, abnormality notification unit 45 may transmit to the external device through the network, the information indicating that an abnormality is present.

Adjustment unit 47 is configured to adjust press working on a workpiece as required, based on the result of the determination by determination unit 44.

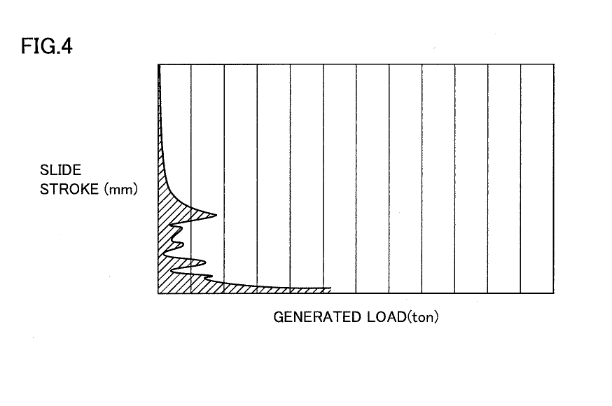

FIG. 4 is a diagram illustrating a load waveform of a press load according to the present embodiment.

FIG. 4 shows a press load generated with stroke of the slide and measured by load sensor 60.

The workload of press machine 1 in the present embodiment is calculated in the following way.

During a pressurization step, calculation unit 43 of controller 40 acquires an amount of slide stroke and a value of a press load measured by load sensor 60 and detected by detection unit 42 to determine an integral value of the product of the amount of slide stroke and the value of the press load, namely to perform integration on the value of the press load and the amount of slide stroke. In the example in FIG. 4, the area of the hatched region corresponds to the workload.

In this example, an allowable load line A is shown to represent an allowable load for a predetermined slide stroke. When a load exceeding allowable load line A is detected, the press machine may be caused to make an emergency stop due to an overload abnormality.

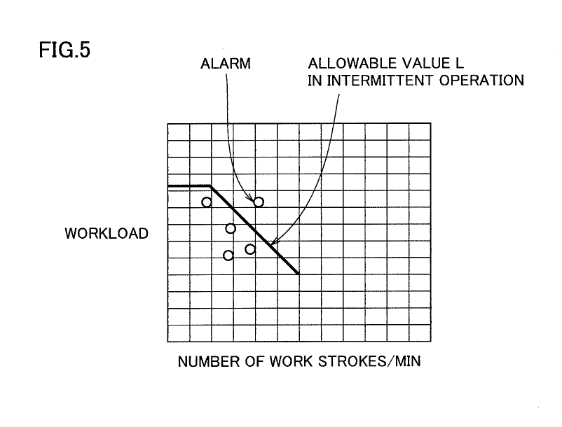

FIG. 5 is a diagram illustrating a method for determining an overload abnormality of press machine 1 according to the present embodiment.

As shown in FIG. 5, in order to detect an overload abnormality of press machine 1, press machine 1 has a protective characteristic. Specifically, press machine 1 stores an allowable value (threshold line) L of the workload of press machine 1 with respect to the number of work strokes during an intermittent operation as shown in FIG. 5. This allowable value L is registered in advance in memory 50. The intermittent operation is a manner of operation that stops slide 4 at the top dead center for each stroke.

The number of work strokes/min is the number of strokes per minute including the time for which the slide is stopped at the top dead center.

In the illustrated case, the larger the number of work strokes, the smaller the limit of allowable value L. Allowable value L is a limit of a tolerable overload amount determined by the specifications of press machine 1 such as the size of flywheel 12 and the rotational speed of electric motor 8.

Specifically, when the number of work strokes is small, the time for electric motor 8 to recover energy to be stored in flywheel 12 (speed recovery time) can be sufficiently long, and therefore, the allowable value of the workload is kept at a predetermined maximum value.

In contrast, as the number of work strokes is larger, the time for electric motor 8 to recover energy to be stored in flywheel 12 (speed recovery time) is shorter. Therefore, as the speed recovery time decreases, the energy that can be recovered to be stored in flywheel 12 depending on the rotational speed and the rotational torque of electric motor 8 decreases. In this illustrated example, the allowable value of the workload decreases like the linear function, by way of example. The slope can be calculated based on a predetermined function with values determined by the specifications of press machine 1 such as the size of flywheel 12 and the rotational speed of electric motor 8.

In the present embodiment, when the workload of press machine 1 is lower than allowable value L, it is determined that the press load for press working is a normal load and, when the workload of press machine 1 is higher than allowable value L, it is determined that the press load for press working is an overload (abnormal load).

When press working is continued with a workload higher than allowable value L, the workload is an overload and accordingly the energy stored in flywheel 12 is excessively consumed, resulting in a decrease of the rotational speed of the flywheel for each stroke, and finally stoppage of the press machine.

In the present embodiment, therefore, when the calculated workload is higher than allowable value L, notification of an abnormality is provided.

This method makes it possible to prevent press working from being continued with a workload higher than allowable value L and thereby suppress stoppage of the press machine due to the abnormality resultant from decrease of the rotational speed of the flywheel.

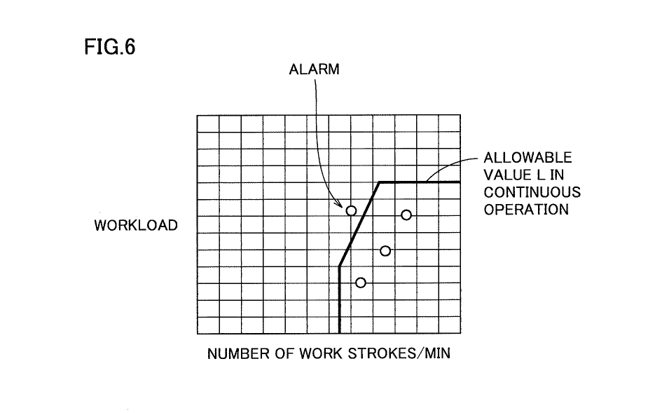

FIG. 6 is another diagram illustrating a method for determining an overload abnormality of press machine 1 according to the present embodiment.

As shown in FIG. 6, in order to detect an overload abnormality of press machine 1, press machine 1 has a protective characteristic. Specifically, press machine 1 stores an allowable value (threshold value) L of the workload of press machine 1 with respect to the number of work strokes during a continuous operation as shown in FIG. 5. This allowable value L is registered in advance in memory 50. The continuous operation is a manner of operation that continues the operation without stopping slide 4 at the top dead center.

The number of work strokes/min is the number of strokes per continuous minute.

In the case of the continuous operation, the rotational speed of electric motor 8 is correlated with the number of work strokes. Specifically, as the number of work strokes increases, the rotational speed of electric motor 8 increases. With the increase of the rotational speed and the rotational torque of electric motor 8, the energy that can be recovered to be stored in flywheel 12 increases. In the illustrated example, the allowable value of the workload increases like the linear function, by way of example. The slope can be calculated based on a predetermined function with values determined by the specifications of press machine 1 such as the size of flywheel 12 and the rate of increase of the rotational speed of electric motor 8. When the rotational speed of electric motor 8 reaches its maximum speed, the allowable value of the workload is kept at a predetermined maximum value.

In the present embodiment, when the workload of press machine 1 is lower than allowable value L, it is determined that the press load for press working is a normal load and, when the workload of press machine 1 is higher than allowable value L, it is determined that the press load for press working is an overload (abnormal load).

When press working is continued with a workload higher than allowable value L, the workload is an overload and accordingly the energy stored in flywheel 12 is excessively consumed, resulting in a decrease of the rotational speed of the flywheel for each stroke, and finally stoppage of the press machine.

In the present embodiment, therefore, when the calculated workload is higher than allowable value L, notification of an abnormality is provided.

This method makes it possible to prevent press working from being continued with a workload higher than allowable value L and thereby suppress stoppage of the press machine due to an abnormality resultant from decrease of the rotational speed of the flywheel.

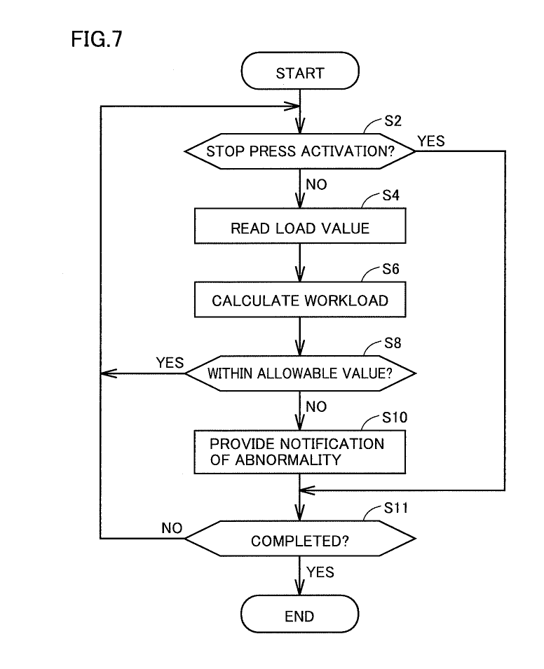

FIG. 7 is a flow diagram illustrating a process for determining an overload abnormality by controller 40 of press machine 1 according to the present embodiment.

As shown in FIG. 7, press machine 1 determines whether an instruction to stop press activation has been given or not (step S2). Detection unit 42 determines whether it has accepted the instruction to stop press activation or not.

When the instruction to stop press activation has been given in step S2 (YES in step S4), press machine 1 ends the process (END). When detection unit 42 has accepted the instruction to stop press activation, press working is stopped.

In contrast, when the instruction to stop press activation has not been given in step S2 (NO in step S2), press machine 1 continues the process.

Press machine 1 reads a load value (step S4). Detection unit 42 acquires a load waveform of the press load from load sensor 60.

Next, press machine 1 calculates the workload (step S6). Calculation unit 43 calculates, as the workload, an integral value of a product of the amount of slide stroke and the press load value.

Next, press machine 1 determines whether the calculated workload is within an allowable value or not (step S8). As described above in connection with FIGS. 5 and 6, determination unit 44 determines whether the workload calculated by detection unit 42 is within allowable value L.

When press machine 1 determines in step S8 that the calculated workload is within the allowable value (YES in step S8), it returns to step S2 to continue the process.

In contrast, when press machine 1 determines in step S8 that the calculated workload is not within the allowable value (NO in step S8), it provides notification of an abnormality (step S10). Determination unit 44 gives an instruction to abnormality notification unit 45. In response to the instruction from determination unit 44, abnormality notification unit 45 provides notification of an abnormality.

Next, press machine 1 determines whether the process has been completed or not (step S11). Determination unit 44 determines whether the press working process has been completed or not.

When press machine 1 determines in step S11 that the process has been completed (YES in step S11), it ends the process (END).

In contrast, when press machine 1 determines that the process continues (NO in step S11), it returns to step S2 to repeat the above-described process.

When a workload higher than allowable value L is detected, abnormality notification unit 45 makes notification of an abnormality. Specifically, it outputs information indicating that press working is overload press working to a display of control panel 70. Alternatively, it may output an alarm sound so as to give to an operator a notification that press working is overload press working. It is also possible to transmit such information to an external device (management device) connected through a network to press machine 1, so that a management staff can keep track of the information.

This method makes it possible to prevent press working from being continued with a workload higher than allowable value L and thereby suppress stoppage of the press machine due to an abnormality resultant from decrease of the rotational speed of the flywheel.

In the illustrated example, notification of an abnormality is provided when a workload higher than allowable value L is detected. The press machine is stopped due to an abnormality when the overload press working is continued. In view of this, the number of times a workload higher than allowable value L is detected may be counted and notification of an abnormality may be provided when the counted number exceeds a predetermined number of times. The design can be changed appropriately so as to change the predetermined number of times by those skilled in the art to an optimum number of times causing no stoppage of the press machine due to an abnormality.

In addition to the notification of an abnormality given by abnormality notification unit 45, adjustment of the press working may be made by adjustment unit 47.

Specifically, when it is determined that the workload is higher than the allowable value based on the result of determination by determination unit 44, adjustment unit 47 may cause the press working to be temporarily stopped.

For example, in order to prevent energy stored in flywheel 12 from being exhausted when overload press working is continued, the press working may be temporarily stopped for the period of one stroke, for example. The temporary stoppage of the press working can prevent overload press working from being continued and thereby prevent stoppage of the press machine due to an abnormality resultant from decrease of the rotational speed of the flywheel.

The energy stored in flywheel 12 also depends on the rotational speed of electric motor 8 rotating flywheel 12.

Accordingly, when it is determined that the workload is higher than the allowable value based on the result of determination by determination unit 44, adjustment unit 47 may adjust the rotational speed of electric motor 8. Specifically, the rotational speed of electric motor 8 can be set to a higher rotational speed. This process adjusts allowable value L to allow the workload to fall in allowable value L and thereby prevent overload press working from being continued and prevent stoppage of the press machine due to an abnormality resultant from decrease of the rotational speed of the flywheel.

This is applicable, but not limited, to flywheel press machines as set forth above. This is also applicable to press machines including electric servo motors.

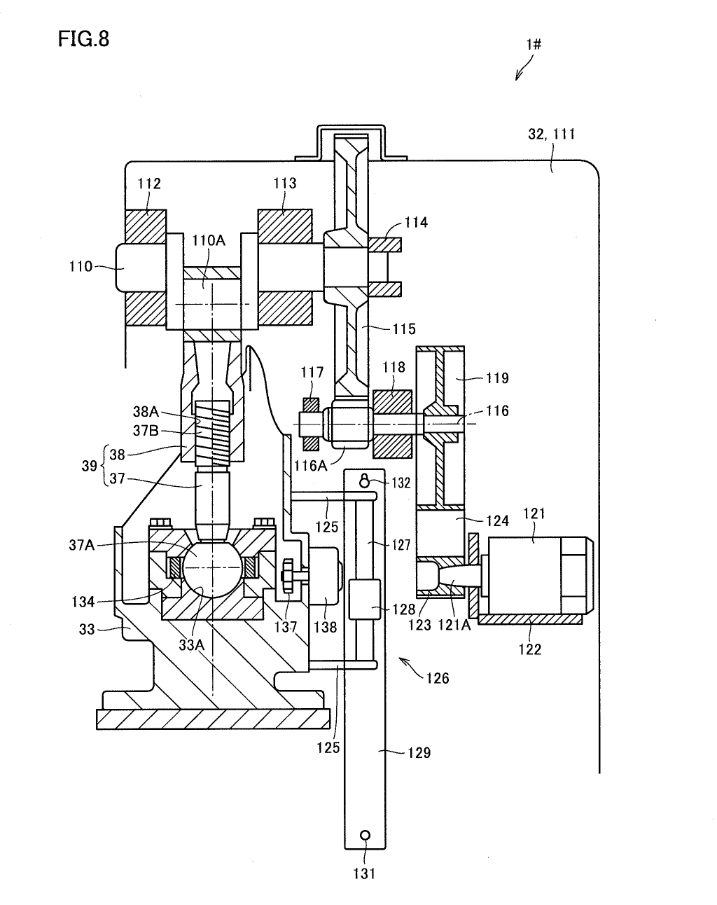

FIG. 8 is a side cross-sectional view showing main parts of a servo press 1#.

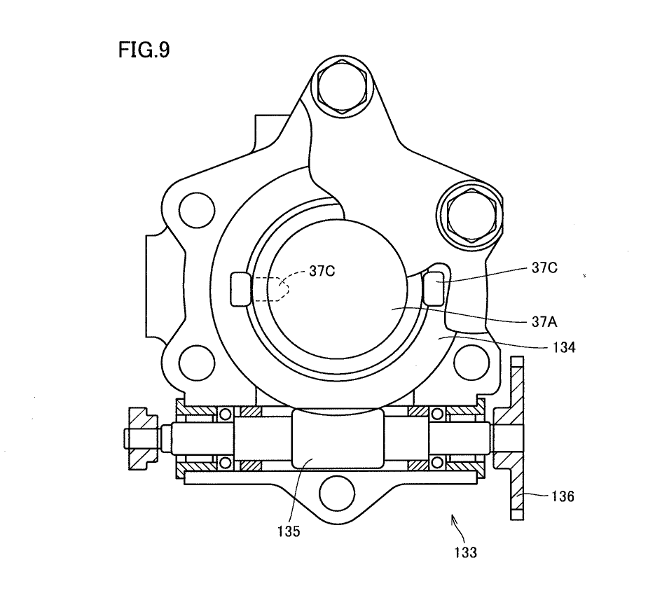

FIG. 9 is a plan view with a partial cross section showing other main parts of servo press 1#.

As shown in FIG. 8, servo press 1# includes a servo motor 121, a spherical hole 33A, a screw shaft 37, a sphere 37A, a thread 37B, a connecting rod body 38, a female thread 38A, a connecting rod 39, a main shaft 110, an eccentric portion 110A, a side frame 111, bearings 112 to 114, a main gear 115, a power transmission shaft 116, a transmission gear 116A, bearings 117, 118, and a pulley 119.

In servo press 1#, servo motor 121 drives slide 33. In spherical hole 33A formed in an upper portion of slide 33, sphere 37A for adjusting the die height is rotatably inserted in such a manner that prevents sphere 37A disposed at the lower end of screw shaft 37 from falling out. Spherical hole 33A and sphere 37A form a spherical joint. Thread 37B of screw shaft 37 is exposed upward from slide 33 and screwed in female thread 38A of connecting rod body 38 disposed above screw shaft 37. Screw shaft 37 and connecting rod body 38 form extendable connecting rod 39.

The die height refers to the distance from the lower surface the slide to the upper surface of the bolster with slide 33 set at the bottom dead center.

An upper portion of connecting rod 39 is rotatably coupled to crank-shaped eccentric portion 110A disposed on main shaft 110. Main shaft 110 is supported between a pair of right and left thick-plate-shaped side frames 111 which form body frame 32, by bearings 112, 113, 114 arranged at respective three positions in the front-rear direction. To the rear side of main shaft 110, main gear 115 is attached.

Main gear 115 meshes with transmission gear 116A of power transmission shaft 116 disposed below main gear 115. Power transmission shaft 116 is supported between side frames 111 by bearings 117, 118 arranged at respective two positions in the front-rear direction. To the rear end of power transmission shaft 116, pulley 119 to be driven is attached. Pulley 119 is driven by servo motor 121 disposed below pulley 119.

Servo press 1# further includes a bracket 122, an output shaft 121A, a pulley 123, a belt 124, a bracket 125, a position detector 126, a rod 127, a position sensor 128, an auxiliary frame 129, and bolts 131, 132.

Servo motor 121 is supported between side frames 111 with substantially L-shaped bracket 122 located therebetween. Output shaft 121A of servo motor 121 protrudes in the front-rear direction of servo press 1#. Motive power is transmitted by belt 124 wound around driven pulley 119 and driver pulley 123 which is disposed on output shaft 121A.

To the back side of slide 33, a pair of brackets 125 is attached that protrude rearward from two positions, namely the upper position and the lower position, toward the space between side frames 111. Between upper and lower brackets 125, rod 127 forming a part of position detector 126 such as linear scale is attached. This rod 127 is equipped with a scale for detecting the position in the top-bottom direction of slide 33, and inserted to be movable up and down through position sensor 128 which also forms a part of position detector 126. Position sensor 128 is secured to auxiliary frame 129 disposed on one side frame 111.

Auxiliary frame 129 is formed in a vertically elongate shape, has its lower portion attached to side frame 111 with bolt 131 and its upper portion supported slidably up and down with bolt 132 which is inserted in a vertically long hole. Thus, only one of the upper side and the lower side (the lower side in the present embodiment) of auxiliary frame 129 is secured to side frame 111, and the other side thereof is supported movably up and down. Therefore, auxiliary frame 129 is not influenced by elongation/contraction, due to temperature variation, of side frames 111. In this way, position sensor 128 is capable of accurately detecting the slide position and the die height position without being influenced by such elongation/contraction of side frames 111.

In contrast, the slide position of slide 33 and the die height are adjusted by a slide position adjustment mechanism 133 disposed in slide 33. As also shown in FIG. 9, slide position adjustment mechanism 133 includes a warm wheel 134 attached to the outer periphery of sphere 37A of screw shaft 37 with a pin 37C, a warm gear 135 meshing with warm wheel 134, an input gear 136 attached to an end of warm gear 135, and an induction motor 138 having an output gear 137 meshing with input gear 136. Induction motor 138 has a flat shape having a relatively shorter axial length and is formed compactly. Rotational motion of induction motor 138 is adjusted by rotating screw shaft 37 through warm wheel 134.

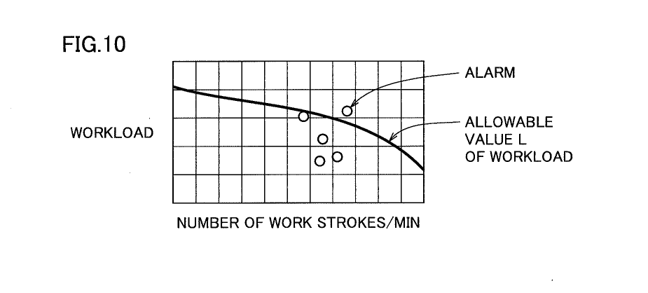

FIG. 10 is a diagram illustrating a method for determining an overload abnormality of another press machine according to the present embodiment.

As shown in FIG. 10, in order to detect an overload abnormality of the press machine, the press machine has a protective characteristic. Specifically, the press machine stores an allowable value (threshold line) L of the workload of the press machine with respect to the number of work strokes per minute.

The allowable value can be set based on data measured through a simulation in advance, by way of example. A desired slide motion is defined, the number of work strokes per minute for the slide motion is set, and an equivalent continuous torque necessary for a servo motor is calculated. The torque load ratio is calculated based on a ratio of a rated torque of the servo motor. Through a simulation, a load is applied to a press machine, and the workload when the torque load ratio reaches 100% is calculated, and the resultant data is stored. The number of work strokes can be changed to obtain the data and thereby obtain allowable value L of the workload of the press machine in the present example.

As to a press machine for which an electric servo motor is used as well, when the workload of the press machine is lower than allowable value L, it is determined that the press load for press working is a normal load and, when the workload of the press machine is higher than allowable value L, it is determined that the press load for press working is an overload (abnormal load).

This method makes it possible to prevent press working from being continued with a workload higher than allowable value L and thereby suppress motor overheating and overcurrent alarm.

While the above description is of the functional characteristics of controller 40 provided in a press machine, the functional characteristics are not limited to the press machine but applicable to a press system including the press machine. For example, when the press machine is connected to an external server through a network, the functions can be performed in cooperation with a CPU of the external server. The indication on the display unit is not limited to indication on the display unit of the press machine, and may be indication on a display unit of a terminal connectable to the press machine through a network.

It should be construed that the embodiments disclosed herein are given by way of illustration in all respects, not by way of limitation. It is intended that the scope of the present invention is defined by claims, not by the description above, and encompasses all modifications and variations equivalent in meaning and scope to the claims.

### REFERENCE SIGNS LIST

1 press machine; 1# servo press; 2 body frame; 3 bolster; 4 slide; 5 lower mold; 6 upper mold; 8 electric motor; 9 power transmission mechanism; 10 transformation mechanism; 12 flywheel; 13 brake device; 14 first gear; 15 second gear; 16 pulley; 17 belt; 40 controller; 42 detection unit; 44 determination unit; 45 abnormality notification unit; 47 adjustment unit; 50 memory; 60 load sensor; 70 control panel

1. A press system comprising:
a detection unit configured to detect a press load applied for pressing a workpiece;
a calculation unit configured to calculate a workload based on the press load detected by the detection unit;
a determination unit configured to make a determination about whether the workload calculated by the calculation unit exceeds an allowable value; and
a notification unit configured to provide notification of an abnormality based on a result of the determination by the determination unit.

2. The press system according to claim 1, wherein
the calculation unit is configured to calculate an integral value of a product of a slide stroke and the press load measured by the measurement unit.

3. The press system according to claim 1, wherein
the notification unit is configured to output abnormality information to a display.

4. The press system according to claim 1, further comprising an adjustment unit configured to adjust pressing of the workpiece based on a result of the determination by the determination unit.

5. A control method for a press system, the control method comprising:
detecting a press load applied for pressing a workpiece;
calculating a workload based on the detected press load;
making a determination about whether the calculated workload exceeds an allowable value; and
providing notification of an abnormality based on a result of the determination.
